(19) United States
(12) Patent Application Publication
(10) Pub. No.: US 2017/0219891 A1
(43) Pub. Date: Aug. 3, 2017

(54) IPS TYPE IN CELL TOUCH DISPLAY PANEL

(71) Applicant: Shenzhen China Star Optoelectronics Technology Co., Ltd., Shenzhen City (CN)

(72) Inventor: Xiangyang Xu, Shenzhen City (CN)

(21) Appl. No.: 14/779,003

(22) PCT Filed: Aug. 24, 2015
(86) PCT No.: PCT/CN2015/087890

§ 371 Date: Sep. 21, 2015

(30) Foreign Application Priority Data
Aug. 3, 2015 (CN) 201510482219.4

(51) Int. Cl. G02F 1/1343; G02F 1/1335; G02F 1/1362; G06F 3/041; G02F 1/1333

(52) U.S. Cl. CPC G02F 1/134363; G06F 3/0412; G02F 1/13338; G02F 1/136286; G02F 1/133514; G02F 1/13439; G02F 2201/121; G02F 2201/124; G02F 2201/123; G02F 2001/134345

(57) ABSTRACT

The present invention provides an IPS type In Cell touch display panel, comprising an array substrate, a CF substrate and a liquid crystal layer arranged between the array substrate and the CF substrate; the array substrate comprises a plurality of gate scan lines (21) separately arranged along a horizontal direction, and the touch scan electrode is shared with the gate scan line (21); an inner side of the CF substrate is provided with a plurality of touch receiving electrodes (40), which are intersecting and perpendicular with the gate scan lines (21) in space. In comparison with the IPS type liquid crystal display panel, the IPS type In Cell touch display panel of the present invention does not require the additional process, and does not decrease the aperture of the panel but can reduce the drive cost of the panel.

### FIELD OF THE INVENTION

The present invention relates to a display technology field, and more particularly to an IPS type In Cell touch display panel.

### BACKGROUND OF THE INVENTION

With the rapid development of the display technology, the touch control display panel has been widely applied and accepted, used by the people. For example, the smart phone, the flat panel computer and etc. all use the touch control display panel. The touch control display panel is to combine the touch control panel and the liquid display panel as one to make the liquid crystal display panel equipped with functions of display and sensing the touch control inputs at the same time.

Generally, the liquid crystal panel mainly comprises a Color Filter (CF), a Thin Film Transistor Array Substrate (TFT Array Substrate) and a Liquid Crystal Layer positioned inbetween. The working principle is that the light of backlight module is reflected to generate images by applying driving voltages to the two glass substrate for controlling the rotations of the liquid crystal molecules. According to the orientation of the liquid crystal, the liquid crystal display panels in the mainstream market can be categorized into several types, which are Vertical Alignment (VA), Twisted Nematic (TN) or Super Twisted Nematic (STN), In-Plane Switching (IPS) and Fringe Field Switching (FFS).

In the IPS type liquid crystal display panel, the liquid crystal molecules are oriented to be parallel relative to the substrate surface, and by applying the transverse electrical field for controlling the rotations of the liquid crystal molecules.

As shown in FIG. 1, the array substrate of the IPS type liquid crystal display panel according to prior art comprises a plurality of gate scan lines 210 separately arranged along a horizontal direction, a plurality of data lines 220 separately arranged along a vertical direction, and a plurality of common electrodes 230 aligned in array, a COM metal line 240 employed to couple with the common electrodes 230 of each row, a comb pixel electrode 250 oppositely positioned to each common electrode 230, and a pixel switch TFT 260 correspondingly positioned to each comb pixel electrode 250. The gate scan line 210 is merely employed for transmitting the scan signal, and the data line 220 is merely employed for transmitting the data signal.

For executing the electromagnetic protection to the IPS type liquid crystal display panel, a whole sheet ITO transparent electrode is provided on the surface at one side of the CF substrate away from the liquid crystal layer i.e. at the backside of the CF substrate.

The touch control display panels can be categorized into four types of resistive, capacitive, optics, surface acoustic wave types according to sensing technology. At present, the main stream touch control technology is the capacitive type. The capacitive type can be further categorized into self capacitive type and mutual capacitive type. The main capacitive type touch control display panel in the present market is the mutual capacitive type, and the advantage of the mutual capacitive type is being able to achieve multi-touch control. The touch display panel can be categorized according to different structures into: On cell, In Cell and Out Cell. The Out Cell touch display panel is to separately produce the touch panel and the liquid crystal display panel, and then to be laminated together to be a display panel having touch control function. The Out Cell has drawbacks of higher manufacture cost, lower light transmittance and thicker module. The In Cell touch display panel has advantages of lower cost and thinner thickness, and it has been favored by respective big display makers and has become the main development direction of the future touch control technology.

In comparison with the IPS liquid crystal display panel, the IPS type In Cell touch display panel requires to add an independent touch control circuit (including the touch scan electrode and the touch receiving electrode) and a drive control part to achieve the touch control function, which does not decrease the aperture ratio of the panel but also increase the difficulty of the process, and raise the drive cost of the panel.

### SUMMARY OF THE INVENTION

An objective of the present invention is to provide an IPS type In Cell touch display panel, and in comparison with the IPS type liquid crystal display panel according to prior art, no additional process is not required, and the aperture ratio of the panel is not decreased but the drive cost of the panel can be reduced.

For realizing the aforesaid objective, the present invention provides an IPS type In Cell touch display panel, comprising: an array substrate, a CF substrate and a liquid crystal layer arranged between the array substrate and the CF substrate;

the array substrate comprises a plurality of gate scan lines separately arranged along a horizontal direction, and the touch scan electrode is shared with the gate scan line;

an inner side of the CF substrate is provided with a plurality of touch receiving electrodes, which are intersecting and perpendicular with the gate scan lines in space.

The array substrate further comprises a plurality of data lines separately arranged along a vertical direction, and a plurality of common electrodes aligned in array, a COM metal line employed to couple with the common electrodes of each row, a comb pixel electrode oppositely positioned to each common electrode, and a pixel switch TFT correspondingly positioned to each comb pixel electrode;

the plurality of gate scan lines separately arranged along the horizontal direction and the plurality of data lines separately arranged along the vertical direction are mutually insulated and staggered to divide a plurality of sub pixel areas; the each common electrode and the comb pixel electrode oppositely positioned thereto are in one sub pixel area.

The touch receiving electrode is correspondingly positioned right above the data line.

A width of the touch receiving electrode is larger than a width of the data line and is smaller than a width of the sub pixel area.

Material of the plurality of touch receiving electrodes is an ITO thin film.

Exposure, etching are implemented to the whole sheet ITO thin film to form the plurality of touch receiving electrodes.

Material of the common electrode and the comb pixel electrode is an ITO thin film.

Material of the gate scan line, the data line and the COM metal line is a stack combination of one or more of molybdenum, titanium, aluminum, copper and nickel.

The present invention further provides an IPS type In Cell touch display panel, comprising: an array substrate, a CF substrate and a liquid crystal layer arranged between the array substrate and the CF substrate;

the array substrate comprises a plurality of gate scan lines separately arranged along a horizontal direction, and the touch scan electrode is shared with the gate scan line;

an inner side of the CF substrate is provided with a plurality of touch receiving electrodes, which are intersecting and perpendicular with the gate scan lines in space;

wherein the array substrate further comprises a plurality of data lines separately arranged along a vertical direction, and a plurality of common electrodes aligned in array, a COM metal line employed to couple with the common electrodes of each row, a comb pixel electrode oppositely positioned to each common electrode, and a pixel switch TFT correspondingly positioned to each comb pixel electrode;

the plurality of gate scan lines separately arranged along the horizontal direction and the plurality of data lines separately arranged along the vertical direction are mutually insulated and staggered to divide a plurality of sub pixel areas; the each common electrode and the comb pixel electrode oppositely positioned thereto are in one sub pixel area;

wherein material of the plurality of touch receiving electrodes is an ITO thin film;

wherein exposure, etching are implemented to the whole sheet ITO thin film to form the plurality of touch receiving electrodes.

The benefits of the present invention are: the present invention provides an IPS type In Cell touch display panel, comprising: an array substrate, a CF substrate and a liquid crystal layer arranged between the array substrate and the CF substrate; the array substrate comprises a plurality of gate scan lines separately arranged along a horizontal direction, and the touch scan electrode is shared with the gate scan line; an inner side of the CF substrate is provided with a plurality of touch receiving electrodes, which are intersecting and perpendicular with the gate scan lines in space. In the IPS type In Cell touch display panel of the present invention, the array substrate has the same structure as the array substrate in the IPS type liquid crystal display panel according to prior art but the touch scan electrode is shared with the gate scan line. No additional process is not required, and the aperture ratio of the panel is not decreased but the drive cost of the panel can be reduced.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a top view diagram of one side of an array substrate of an IPS type liquid crystal display panel according to prior art;

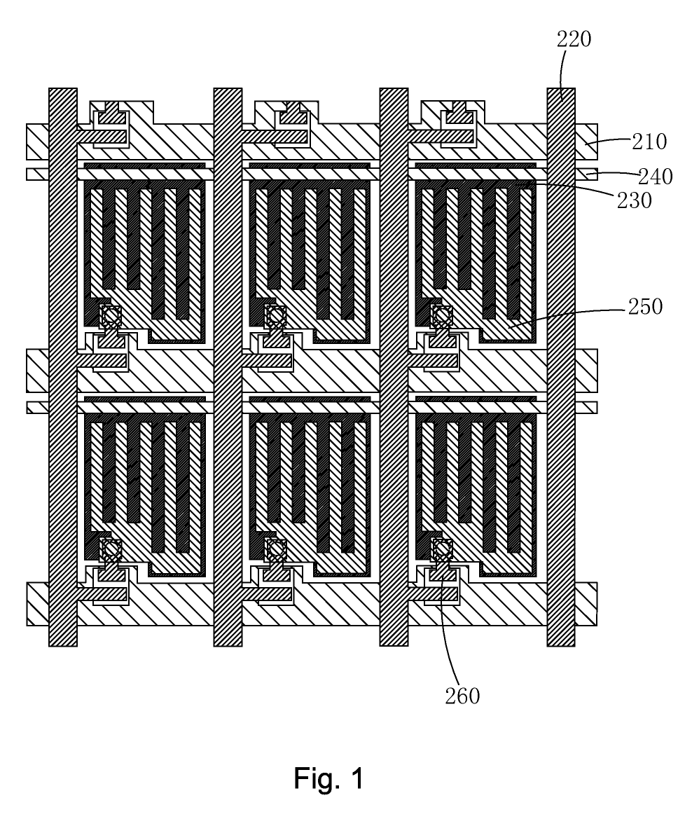

FIG. 2 is a top view diagram of an IPS type In Cell touch display panel according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

The present invention provides an IPS type In Cell touch display panel, comprising: an array substrate, a CF substrate and a liquid crystal layer arranged between the array substrate and the CF substrate.

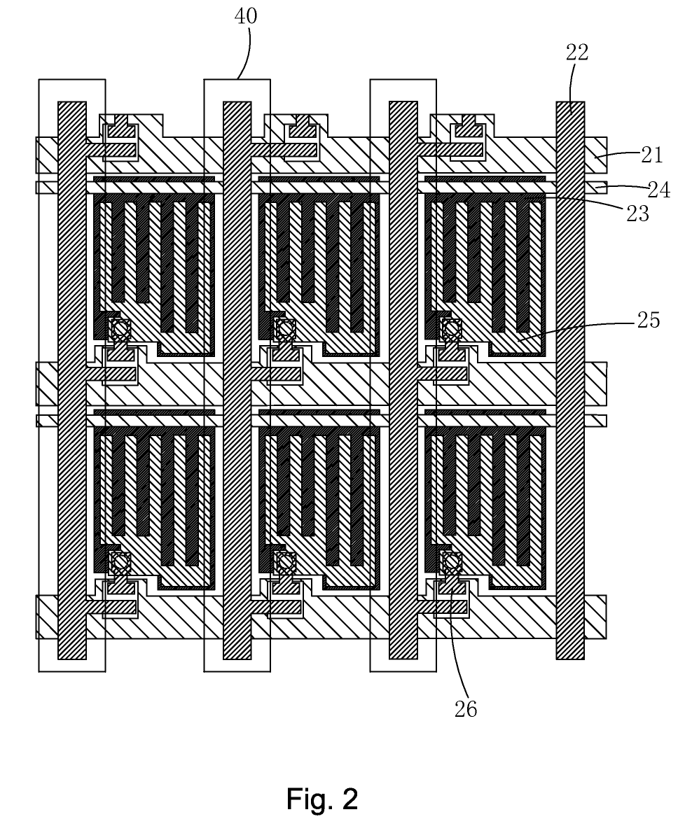

AS shown in FIG. 2, the array substrate comprises a plurality of gate scan lines 21 separately arranged along a horizontal direction, a plurality of data lines 22 separately arranged along a vertical direction, and a plurality of common electrodes 23 aligned in array, a COM metal line 24 employed to couple with the common electrodes 23 of each row, a comb pixel electrode 25 oppositely positioned to each common electrode 23, and a pixel switch TFT 26 correspondingly positioned to each comb pixel electrode 25.

The plurality of gate scan lines 21 separately arranged along the horizontal direction and the plurality of data lines 22 separately arranged along the vertical direction are mutually insulated and staggered to divide a plurality of sub pixel areas; the each common electrode 23 and the comb pixel electrode 25 oppositely positioned thereto are in one sub pixel area.

The touch scan electrode is shared with the gate scan line 21.

The gate scan line 21, the COM metal line 24 and the gate of the pixel switch TFT 26 are at the same layer, and formed by patterning a first metal layer. Material of the first metal layer is a stack combination of one or more of one or more of molybdenum (Mo), titanium (Ti), aluminum (Al), copper (Cu) and nickel (Ni). The gate of the pixel switch TFT 26 is coupled to the gate scan line 21.

The gate scan line 21 and the data line 22 sandwich an insulative layer (not shown) inbetween. The data line 22 and the source, the drain of the pixel switch TFT 26 are at the same layer, and formed by patterning a second metal layer. Material of the second metal layer is a stack combination of one or more of one or more of Mo, Ti, Al, Cu and Ni. The source of the pixel switch TFT 26 is coupled to the data line 22, and both the source and the drain of the pixel switch TFT 26 contact with the semiconductor layer.

A passivation protective layer (not shown) covers on the data line 22, the source and the drain of the pixel switch TFT 26. The comb pixel electrode 25 is oppositely positioned to the common electrode 23 on the passivation protective layer, and the comb pixel electrode 25 is coupled to the drain of the pixel switch TFT 26 through the via penetrating the passivation protective layer. Material of common electrode 23 and the comb pixel electrode 25 is an Indium Tin Oxide (ITO) thin film.

As known from the aforesaid description, the array substrate has the same structure as the array substrate in the IPS type liquid crystal display panel according to prior art but the touch scan electrode is shared with the gate scan line 21. No additional process is not required, and the aperture ratio of the panel is not decreased. The gate scan line 21 transmits a scan pulse signal in the display period, and is employed to be touch scan electrode to transmit a touch scan signal in the non-display period. The solo drive of the touch scan is not required to reduce the drive cost of the panel.

An inner side of the CF substrate is provided with a plurality of touch receiving electrodes 40, which are intersecting and perpendicular with the gate scan lines 21 in space. Unlike the CF substrate in the IPS type liquid crystal display panel according to prior art, a whole sheet ITO transparent electrode is provided at the backside for electromagnetic protection. Besides, the structure of the CF substrate is the same as the CF substrate in the IPS type liquid crystal display panel according to prior art, and comprises components of color film photoresist, a black matrix, photospacers and alignment films. The detail description is omitted here.

Furthermore, the touch receiving electrode 40 is correspondingly positioned right above the data line 22. A width of the touch receiving electrode 40 is larger than a width of the data line 22 and is smaller than a width of the sub pixel area.

Exposure, etching are implemented to the whole sheet ITO thin film to form the plurality of touch receiving electrodes 40.

The touch receiving electrode 40 cooperates and shares the touch scan electrode with the gate scan line 21 to achieve the touch control function.

In conclusion, the IPS type In Cell touch display panel of the present invention comprises: an array substrate, a CF substrate and a liquid crystal layer arranged between the array substrate and the CF substrate; the array substrate comprises a plurality of gate scan lines separately arranged along a horizontal direction, and the touch scan electrode is shared with the gate scan line; an inner side of the CF substrate is provided with a plurality of touch receiving electrodes, which are intersecting and perpendicular with the gate scan lines in space. In the IPS type In Cell touch display panel of the present invention, the array substrate has the same structure as the array substrate in the IPS type liquid crystal display panel according to prior art but the touch scan electrode is shared with the gate scan line. No additional process is not required, and the aperture ratio of the panel is not decreased but the drive cost of the panel can be reduced.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. An IPS type In Cell touch display panel, comprising: an array substrate, a CF substrate and a liquid crystal layer arranged between the array substrate and the CF substrate;
the array substrate comprises a plurality of gate scan lines separately arranged along a horizontal direction, and the touch scan electrode is shared with the gate scan line;
an inner side of the CF substrate is provided with a plurality of touch receiving electrodes, which are intersecting and perpendicular with the gate scan lines in space.

2. The IPS type In Cell touch display panel according to claim 1, wherein the array substrate further comprises a plurality of data lines separately arranged along a vertical direction, and a plurality of common electrodes aligned in array, a COM metal line employed to couple with the common electrodes of each row, a comb pixel electrode oppositely positioned to each common electrode, and a pixel switch TFT correspondingly positioned to each comb pixel electrode;
the plurality of gate scan lines separately arranged along the horizontal direction and the plurality of data lines separately arranged along the vertical direction are mutually insulated and staggered to divide a plurality of sub pixel areas; the each common electrode and the comb pixel electrode oppositely positioned thereto are in one sub pixel area.

3. The IPS type In Cell touch display panel according to claim 2, wherein the touch receiving electrode is correspondingly positioned right above the data line.

4. The IPS type In Cell touch display panel according to claim 3, wherein a width of the touch receiving electrode is larger than a width of the data line and is smaller than a width of the sub pixel area.

5. The IPS type In Cell touch display panel according to claim 1, wherein material of the plurality of touch receiving electrodes is an ITO thin film.

6. The IPS type In Cell touch display panel according to claim 5, wherein exposure, etching are implemented to the whole sheet ITO thin film to form the plurality of touch receiving electrodes.

7. The IPS type In Cell touch display panel according to claim 2, wherein material of the common electrode and the comb pixel electrode is an ITO thin film.

8. The IPS type In Cell touch display panel according to claim 2, wherein material of the gate scan line, the data line and the COM metal line is a stack combination of one or more of molybdenum, titanium, aluminum, copper and nickel.

9. An IPS type In Cell touch display panel, comprising: an array substrate, a CF substrate and a liquid crystal layer arranged between the array substrate and the CF substrate;
the array substrate comprises a plurality of gate scan lines separately arranged along a horizontal direction, and the touch scan electrode is shared with the gate scan line;
an inner side of the CF substrate is provided with a plurality of touch receiving electrodes, which are intersecting and perpendicular with the gate scan lines in space;
wherein the array substrate further comprises a plurality of data lines separately arranged along a vertical direction, and a plurality of common electrodes aligned in array, a COM metal line employed to couple with the common electrodes of each row, a comb pixel electrode oppositely positioned to each common electrode, and a pixel switch TFT correspondingly positioned to each comb pixel electrode;
the plurality of gate scan lines separately arranged along the horizontal direction and the plurality of data lines separately arranged along the vertical direction are mutually insulated and staggered to divide a plurality of sub pixel areas; the each common electrode and the comb pixel electrode oppositely positioned thereto are in one sub pixel area;
wherein material of the plurality of touch receiving electrodes is an ITO thin film;
wherein exposure, etching are implemented to the whole sheet ITO thin film to form the plurality of touch receiving electrodes.

10. The IPS type In Cell touch display panel according to claim 9, wherein the touch receiving electrode is correspondingly positioned right above the data line.

11. The IPS type In Cell touch display panel according to claim 10, wherein a width of the touch receiving electrode is larger than a width of the data line and is smaller than a width of the sub pixel area.

12. The IPS type In Cell touch display panel according to claim 9, wherein material of the common electrode and the comb pixel electrode is an ITO thin film.

13. The IPS type In Cell touch display panel according to claim 9, wherein material of the gate scan line, the data line and the COM metal line is a stack combination of one or more of molybdenum, titanium, aluminum, copper and nickel.
